(19) United States
(12) Patent Application Publication
(10) Pub. No.: US 2025/0147175 A1
(43) Pub. Date: May 8, 2025

(54) RADAR DEVICE AND IN-VEHICLE-OBJECT DETECTION METHOD FOR RADAR DEVICE

(71) Applicant: MILLILAB CO., LTD., HSINCHU CITY (TW)

(72) Inventors: Yucheng LIN, HSINCHU CITY (TW); Jyun-Yu CHEN, HSINCHU CITY (TW)

(21) Appl. No.: 18/386,584

(22) Filed: Nov. 2, 2023

(51) Int. Cl. G01S 13/931; B60W 30/08

(52) U.S. Cl. CPC G01S 13/931; B60W 30/08; B60W 2420/408; B60W 2554/4049

(57) ABSTRACT

An in-vehicle-object detection method for a radar device includes: a) obtaining multiple receiving signals corresponding to multiple space objects by an antenna array of the radar device; b) computing multiple first distances between the antenna array and the multiple space objects based on the multiple receiving signals; c) filtering a background noise of the multiple first distances to obtain multiple second distances between multiple indeterminate objects of the multiple space objects and the antenna array; d) performing a beamforming based on the multiple second distances to compute angle information corresponding to each of the multiple second distances; e) generating a distance-angle heatmap including multiple regions of interest (ROIs); and f) determining whether each ROI in the distance-angle heatmap is associated with a human feature to decide whether each of the indeterminate objects is related to human or unhuman.

### BACKGROUND OF THE DISCLOSURE

### Technical Field

The disclosure relates to a radar device and a method for the radar device, and more particularly, to a radar device for detecting an object in a vehicle and an in-vehicle-object detection method for the radar device.

### Description of Related Art

Vehicle safety, especially passenger safety, is a major issue that each driver worries about. Suppose that the passenger is a child who encounters dangerous or accidental situations, the child will be injured badly due to lacking the ability of taking care of himself/herself. Recently, safety-monitoring services for children in vehicles which are provided by vehicle makers grows, while vehicle-related regulations of child safety made by the government grows as well. It is obvious that more and more vehicle safety issues transfer from the driver orientation to the passenger orientation.

The related art utilizes cameras in the vehicles to capture images in the vehicle and detects passengers in the vehicle by image processing techniques. However, the related art depends on the image processing techniques, such as image identification of the captured image inside the vehicle or image coordinate transformations which compute pixel distances of the image and transform the pixel distances to distance information. The image processing techniques involve entire image pixels. As a result, the related art consumes high computations and the detection result is delayed and inaccurate.

Accordingly, a technical solution about how to effectively detect passengers in a vehicle is required.

### SUMMARY OF THE DISCLOSURE

One of the exemplary embodiments of the present disclosure is to provide an in-vehicle-object detection method for a radar device including: a) obtaining a plurality of receiving signals corresponding to a plurality of space objects by an antenna array of the radar device; b) computing a plurality of first distances between the antenna array and the plurality of space objects based on the plurality of receiving signals; c) filtering a background noise of the plurality of first distances to obtain a plurality of second distances between a plurality of indeterminate objects of the plurality of space objects and the antenna array; d) performing a beamforming based on the plurality of second distances to compute a plurality of angle information each corresponding to each of the plurality of second distances; e) generating a distance-angle heatmap including a plurality of regions of interest (ROIs), where each of the plurality of ROIs corresponds to a passenger-seat position in the vehicle; and f) determining whether each of the plurality of ROIs in the distance-angle heatmap is associated with a human feature to decide whether each of the indeterminate objects is related to a human or an unhuman.

One of the exemplary embodiments of the present disclosure is to provide a radar device for detecting an object in a vehicle including an antenna array and a microprocessor. The antenna array is configured to receive a plurality of receiving signals. The microprocessor is connected to the antenna array and configured to perform operations including: a) receiving the plurality of receiving signals corresponding to a plurality of space objects; b) obtaining a plurality of first distances between the antenna array and the plurality of space objects based on the plurality of receiving signals; c) filtering a background noise of the plurality of first distances to obtain a plurality of second distances between a plurality of indeterminate objects of the plurality of space objects and the antenna array; d) performing a beamforming based on the plurality of second distances to compute a plurality of angle information each corresponding to each of the plurality of second distances; e) generating a distance-angle heatmap including a plurality of regions of interest (ROIs), where each of the plurality of ROIs corresponds to a passenger-seat position in the vehicle; and f) determining whether each of the plurality of ROIs in the distance-angle heatmap is associated with a human feature to decide whether each of the indeterminate objects is related to a human or an unhuman.

The disclosure provides the technical features to increase the efficiency of detecting whether the object in the vehicle is related to the human and the accuracy of detecting whether there is a human in the vehicle.

### BRIEF DESCRIPTION OF THE DRAWINGS

FIG. 1 is a schematic diagram of a radar device for detecting objects in a vehicle according to an embodiment of the present disclosure.

FIG. 2 is a schematic diagram of the radar device for detecting objects in the vehicle according to another embodiment of the disclosure.

FIG. 3 is a block diagram of the radar device for detecting objects in the vehicle according to an embodiment of the disclosure.

FIG. 4 is a flowchart of an in-vehicle-object detection method according to an embodiment of the disclosure.

FIG. 5 is a schematic diagram illustrating the radar device detecting the object in the vehicle according to an embodiment of the present disclosure.

FIG. 6 is a schematic diagram illustrating the relationship between the receiving signals and the distances between the radar device and the object in the vehicle.

FIG. 7 is a schematic diagram of a distance-angle heatmap including a plurality of regions of interest (ROIs) according to an embodiment of the present disclosure.

FIG. 8 is a flowchart of the in-vehicle-object detection method for performing a human feature detection process according to an embodiment of the present disclosure.

FIG. 9 is a schematic diagram of marking distance-angle-information grids in the ROIs according to an embodiment of the present disclosure.

FIG. 10 is a schematic diagram of marking the distance-angle-information grids in the ROIs according to another embodiment of the present disclosure.

FIG. 11 is a flowchart of the in-vehicle-object detection method for performing the human feature detection process according to another embodiment of the present disclosure.

FIG. 12 is a schematic diagram illustrating angle-energy information according to an embodiment of the present disclosure.

FIG. 13 is a schematic diagram illustrating the angle-energy information according to another embodiment of the present disclosure.

FIG. 14 is a flowchart of the in-vehicle-object detection method for performing the human feature detection process according to another embodiment of the present disclosure.

FIG. 15 is a schematic diagram of analyzing human physiological feature signals according to an embodiment of the present disclosure.

FIG. 16 is a schematic diagram of analyzing the human physiological feature signals according to another embodiment of the present disclosure.

FIG. 17 is a flowchart of determining whether the ROI of the distance-angle heatmap is associated with the human features according to an embodiment of the present disclosure.

### DETAILED DESCRIPTION

Reference will now be made in detail to the present embodiments of the disclosure, examples of which are illustrated in the accompanying drawings. Wherever possible, the same reference numbers are used in the drawings and the description to refer to the same or like parts.

The technical terms “first”, “second”, and similar terms are used to describe elements for distinguishing the same or similar elements or operations and are not intended to limit the technical elements and the order of the operations in the present disclosure. Furthermore, the element symbols/alphabets can be used repeatedly in each embodiment of the present disclosure. The same and similar technical terms can be represented by the same or similar symbols/alphabets in each embodiment. The repeated symbols/alphabets are provided for simplicity and clarity and they should not be interpreted to limit the relation of the technical terms among the embodiments.

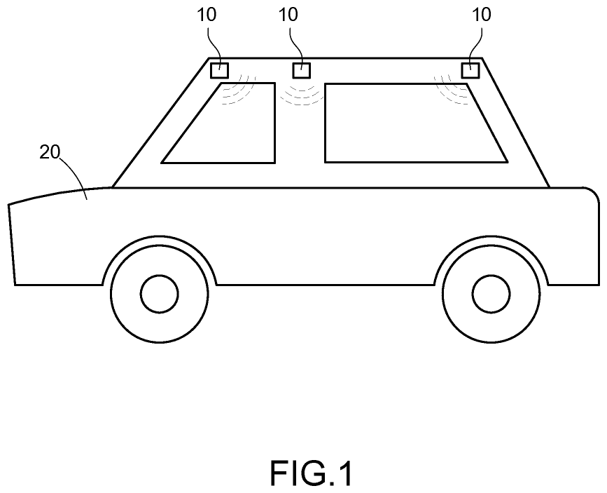

Reference is made to FIG. 1. FIG. 1 is a schematic diagram of a radar device for detecting objects in a vehicle according to an embodiment of the present disclosure. The radar device 10 is disposed inside the vehicle 20. For example, the radar device 10 is set at the position near the interior rearview mirror or combined into the interior rearview mirror, so the radar device 10 emits signals towards the driving seat, the front passenger seat, and the back seat.

In another embodiment, the radar device 10 is disposed at the approximate center of the headlining or the upper-border side of the rear windscreen, so the radar device 10 emits signals towards the driving seat and all the passenger seats and receives reflected radar-wave signals of the driver, the passengers, and/or the passenger seats. The radar device 10 is set at the position with no obstacles within the respective line-of-sight position between the radar device 10 and all the seats (the driver seat, the front passenger seats, and the back seats).

It should be noted that the three positions of the radar device 10 shown in FIG. 1 indicate the embodiment that the radar device 10 is selectively disposed at one of the three positions to emit signals towards all the passengers and/or the seats in the vehicle and receive the reflected radar-wave signals.

In one embodiment, the vehicle 20 is the transportation equipment having a housing for carrying passengers or goods. The vehicle 20 may be but not limited to powered vehicles for driving on roads (such as compact cars or buses) or railway vehicles.

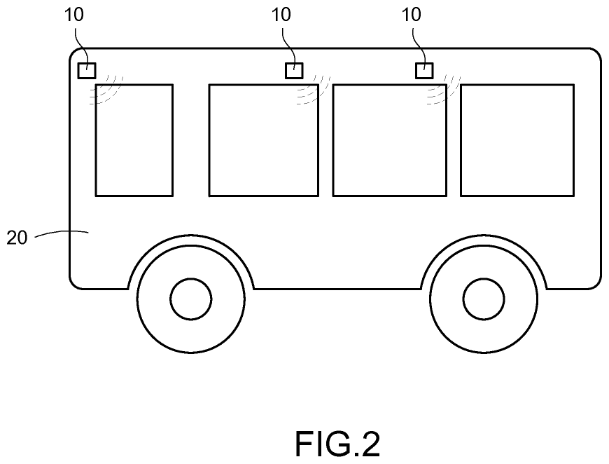

FIG. 2 is a schematic diagram of the radar device for detecting objects in the vehicle according to another embodiment of the disclosure. In comparison with the embodiment of FIG. 1 that one radar device 10 is disposed inside the vehicle 20, three radar devices 10 are disposed inside the vehicle 20 at the same time while the vehicle 20 is a large transportation vehicle (such as buses) in the embodiment of FIG. 2. Each radar device 10 performs the same operations (described below) to achieve object detections without any blind spot in the vehicle 20.

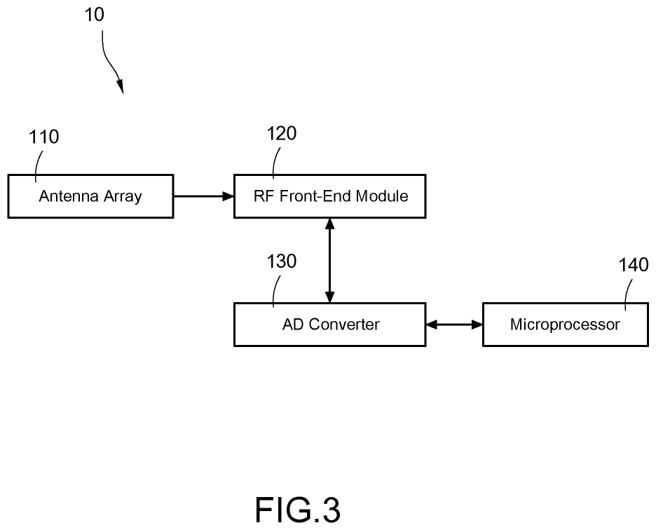

Reference is made to FIG. 3. FIG. 3 is a block diagram of the radar device for detecting objects in the vehicle according to an embodiment of the disclosure. The radar device 10 includes an antenna array 110, a radio-frequency (RF) front-end module 120, an analog-to-digital (AD) converter 130, and a microprocessor 140.

The RF front-end module 120 is electrically connected to the antenna array 110 and the AD converter 130. The AD converter 130 is electrically connected to the microprocessor 140.

In an embodiment, the antenna array 110 includes a plurality of antennas, and each antenna is configured to be the reception antenna or the transmission antenna. The antenna array 110 is configured to be the antenna module with Multi-Input Multi-Output (MIMO) function, such as four transmission antennas and four reception antennas, but the quantity of the antennas is not limited.

In an embodiment, the RF front-end module 120 is configured to control the antenna array 110 to emit radar signals, receive reflected radar-wave signals, and process the received reflected radar-wave signals. For example, the antenna array 110 is configured to receive the reflected radar-wave signals, and the RF front-end module 120 filters and amplifies the reflected radar-wave signals received by the antenna array 110 to generate antenna-processed signals (analog reception signals).

In an embodiment, the AD converter 130 is configured to transform the antenna-processed signals from the analog reception signals into digital reception signals (called “receiving signals” hereinafter). In brief, the antenna array 110 receives a plurality of receiving signals.

In an embodiment, the microprocessor 140 performs a signal processing to the receiving signals to perform the object detection in the vehicle (such as detecting whether any human feature in the vehicle) which is described below.

In an embodiment, the microprocessor 140 may be but not limited to a Digital Signal Processor (DSP), an Application Specific Integrated Circuit (ASIC), a Central Processing Unit (CPU), a System on Chip (SoC), a Field Programmable Gate Array (FPGA), a Network Processor IC, or the combination of the components above.

In an embodiment, antenna array 110 that operates in mmWave is disposed in the radar device 10 to minimize the volume of the radar device 10.

In an embodiment, the radar device 10 connects to the vehicle system or the electronic control units (ECU) (not shown in FIG. 1 and FIG. 2) of the vehicle 20 by a wired manner (such as the Universal Serial Bus (USB) or a micro connector) or a wireless manner (such as the Wireless Fidelity (Wi-Fi), the Bluetooth, the Zigbee, or other wireless area network communications. Communication components (not shown in figures) of the vehicle system or the ECU sends results of detecting the object in the vehicle that is computed by the radar device 10 to a user electronic device (not shown in figures), so the user gets notified when someone is left in the vehicle.

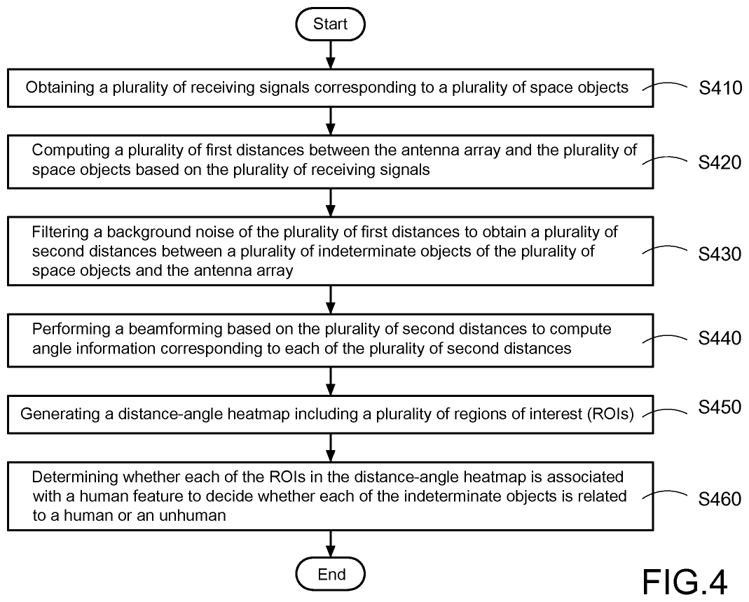

Reference is made to FIG. 4. FIG. 4 is a flowchart of an in-vehicle-object detection method according to an embodiment of the disclosure. The in-vehicle-object detection method is performed by the radar device 10 in FIG. 3. The following description is incorporated with the radar device 10 for each step of the in-vehicle-object detection method.

In step S410, the microprocessor 140 obtains a plurality of receiving signals corresponding to a plurality of space objects by the antenna array 110, the RF front-end module 120, and the AD converter 130.

In step S420, the microprocessor 140 computes a plurality of first distances between the antenna array 110 and the plurality of space objects based on the plurality of receiving signals.

In step S430, the microprocessor 140 filters a background noise of the plurality of first distances to obtain a plurality of second distances between a plurality of indeterminate objects of the plurality of space objects and the antenna array.

In step S440, the microprocessor 140 performs a beamforming based on the plurality of second distances to compute angle information corresponding to each of the plurality of second distances.

In step S450, the microprocessor 140 generates a distance-angle heatmap including a plurality of regions of interest (ROIs).

In step S460, the microprocessor 140 determines whether each of the ROIs in the distance-angle heatmap is associated with a human feature to decide whether each of the indeterminate objects is related to a human or an unhuman.

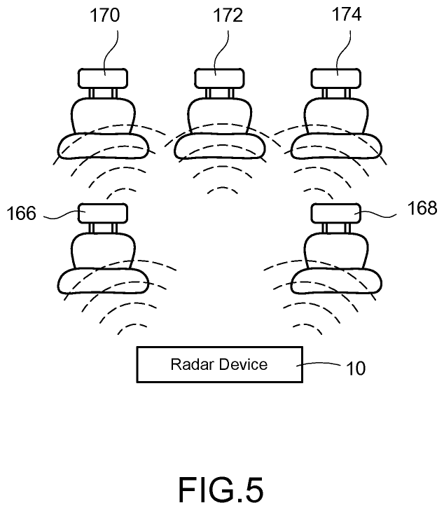

In step S410 the microprocessor 140 obtains the plurality of receiving signals corresponding to the plurality of space objects by the antenna array 110, the RF front-end module 120, and the AD converter 130. Reference is made to FIG. 5. FIG. 5 is a schematic diagram illustrating the radar device detecting the object in the vehicle according to an embodiment of the present disclosure. As shown in FIG. 5, the in-vehicle object includes passenger-seat positions 166, 168, 170, 172, and 174. In the embodiment, the radar device 10 is disposed on the front windscreen of the vehicle 20, and the radio-emitting direction of the radar device 10 is towards the interior space of the vehicle 20.

The radar device 10 emits radio waves towards the plurality of passenger seats based on a plurality of default angles and detects the distances between each of the in-vehicle objects (such as the passengers, the positions of vacant seats, or other object in the vehicle 20) in the interior space of the vehicle 20 and the radar device 10. For example, the radar device 10 emits radio waves towards a first direction where shifting the front-view direction (0-degree position) for 45 degrees to the left (e.g., a −45-degree position) and detects the distance between the passenger-seat position 166 and the radar device 10 which is 75 centimeters. Similarly, the radar device 10 emits radio waves towards a second direction where shifting the front-view direction (0-degree position) for 30 degrees to the right (e.g., a +30-degree position) and detects the distance between the passenger-seat position 174 and the radar device 10 which is 170 centimeters. However, due to signal interferences, the radar device 10 does not confirm yet at this stage about which direction and distance of the detected signal is associated with the object or the passenger. What the radar device 10 confirms by the detected signals in this stage is the distance range and the angle range in the interior space.

The transmission antenna of the antenna array 110 emits the radar signal, and the reception antenna of the antenna array 110 receives the radar signal (the reflected radar-wave signal) reflected by the plurality of space objects in the vehicle 20. The radar device 10 processes the reflected radar-wave signal by the analog-to-digital conversion, the filtering process, and the signal amplifying process to obtain the antenna-processed signal.

In an embodiment, the microprocessor 140 performs the discrete Fourier transform to transform the antenna-processed signal to obtain the plurality of receiving signals corresponding to the plurality of space objects in the vehicle 20. At the moment, the reception signal is a frequency signal.

In some cases, the diffraction or scatterings of the reflected radar-wave signal in the air may cause the energy value (amplitude) of the frequency value to be small.

In step S420, the microprocessor 140 selects the frequency signal having an amplitude that is greater than an energy threshold and filters the frequency signal having an amplitude that is less than the energy threshold. The remained frequency signals are used to compute the first distances.

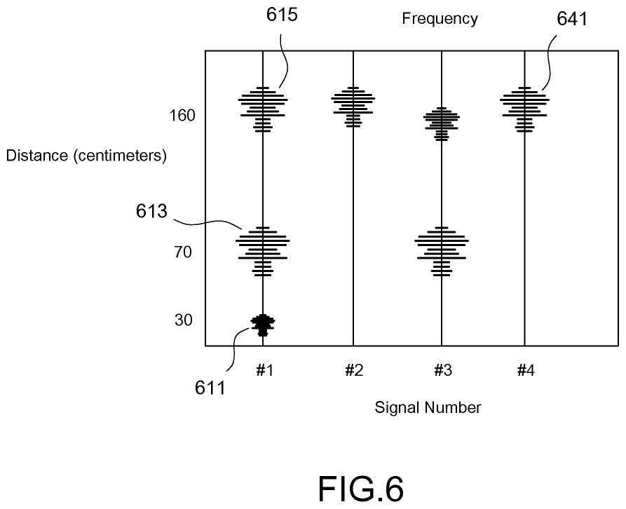

Reference is made to FIG. 6. FIG. 6 is a schematic diagram illustrating the relationship between the receiving signals and the distances between the radar device and the object in the vehicle.

As shown in FIG. 6, the signal numbered 1 (#1) includes frequencies 611, 613, and 615. Because the energy value of the frequency 611 is less than the energy threshold, the microprocessor 140 filters the frequency 611 of the signal numbered 1 (#1) and keeps the frequencies 613 and 615 that have energy values greater than the energy threshold. Similarly, the signal numbered 4 (#4) includes a frequency 641, and the energy value of the frequency 641 is greater than the energy threshold, so the microprocessor 140 keeps the frequency 641 of the signal numbered 4 (#4).

In an embodiment, the microprocessor 140 obtains the detected space objects in the interior space of the vehicle 20 and the distances (i.e., the first distances) between the space objects and the radar device 20 based on the detected distance and the energy value of the frequency signal in according to a default relationship.

In an embodiment, the default relationship includes the energy value of the frequency and the distance. For example, as shown in FIG. 6, the energy of the frequency 613 of the signal numbered (#1) corresponds to the distance that is 70 centimeters, and the energy value of the frequency 615 corresponds to the distance that is 160 centimeters. In the embodiment, the first distances obtained by the microprocessor 140 are 70 centimeters and 160 centimeters. In this situation, the microprocessor 140 obtains the information that the space objects are respectively located at positions of 70 centimeters and 160 centimeters away from the radar device 10 in the interior space of the vehicle 20.

Because the space objects may be the passenger seats or other existing equipment in the vehicle 20, it is required to further confirm which object is related to an unhuman by analyzing the received signals.

In step S430, the microprocessor 140 computes a speed of the space objects according to the receiving signals and removes the distance corresponding to the speed being close to zero from the plurality of first distances to obtain the plurality of second distances. For example, the microprocessor 140 computes the distance between the radar device 10 and each space object at each time point when receiving the receiving signal and then computes the speed of each space object according to distance differences and time differences.

In an embodiment, when the speed is close to zero (e.g., the detected value is close to zero because of measuring errors but it is determined to be the object at the position fixed in the vehicle 20) or is zero, it represents that the space object in the vehicle is immovable. Therefore, the microprocessor 140 eliminates the possibility that the space object is related to the passenger and then removes the distance corresponding to the space object from the plurality of first distances. As shown in FIG. 6, when determining that the space object at the position of 70 centimeters away from the radar device 20 is immovable according to the signal numbered 1 (#1), the microprocessor 140 removes the distance, 70 centimeters, from the first distances. That is, the microprocessor 140 filters the background noise to remove the object that is impossible to be the human feature and tags the remaining space objects as the indeterminate objects. The distances related to the indeterminate objects are set to be the second distances.

In step S440, the microprocessor 140 performs the discrete Fourier transform to the plurality of second distances whose background noises are filtered to obtain the angle information to be the second distance-angle information, wherein each second distance-angle information includes each second distance and the angle information corresponding to each second distance.

It should be noted that the second distance-angle information is a two-data set formed by the second distance and the angle information corresponding to the second distance. The technical term “second distance-angle information” is not limited to whether “the first distance-angle information” is generated and whether “the first distance-angle information” is obtained earlier than the second distance-angle information. That is, the terms “first” and “second” are not intended to be the sequence or the order in the invention.

In an embodiment, the microprocessor 140 obtains a vector array by taking each of the plurality of second distances as a column vector, performs the discrete Fourier transform to each row vector of the vector array, and computes the plurality of angle information (phases) by the plurality of second distances whose background noise are filtered. Therefore, the radar device 10 obtains the distance between the radar device 10 and the indeterminate objects in the interior space of the vehicle 20 and the corresponding angle information to obtain the second distance-angle information of each indeterminate object.

In step S450, the microprocessor 140 generates the distance-angle heatmap according to the second distance-angle information of the indeterminate objects and draws the regions of interest (ROIs) in the distance-angle heatmap.

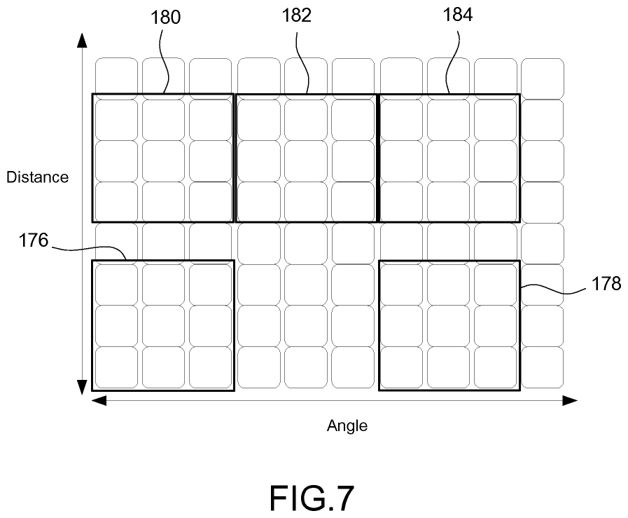

Reference is made to FIG. 7. FIG. 7 is a schematic diagram of the distance-angle heatmap including the plurality of regions of interest (ROIs) according to an embodiment of the present disclosure. In FIG. 7, the x-axis of the distance-angle heatmap indicates the angle (in FIG. 5, taking the front-view direction (0-degree angle) of the radar device 10 as a baseline and respectively shifting an angle to the left and right to define one angle range), and the y-axis of the distance-angle heatmap indicates the distance (such as the distance range from a shortest distance to a longest distance that the radar device 10 detects).

In an embodiment, the data type of the distance-angle heatmap stored is image data.

As shown in FIG. 7, the distance-angle heatmap includes the ROIs 176, 178, 180, 182, and 184. For example, the ROI 180 is the region formed based on the second distance-angle information obtained in step S440.

It should be noted that the microprocessor 140 obtains the ROI 180 and draws other ROI(s), such as the ROIs 176, 178, 182, and 184, according to the instance situation at the same time. For the sake of brevity, the similar operations of drawing the 176, 178, 182, and 184 are not repeated.

In an embodiment, each ROI corresponds to one passenger-seat position in the vehicle 20. For example, the ROI 176 corresponds to the passenger-seat position 166 as shown in FIG. 5; the ROI 178 corresponds to the passenger-seat position 168 as shown in FIG. 5; the ROI 180 corresponds to the passenger-seat position 170 as shown in FIG. 5; the ROI 182 corresponds to the passenger-seat position 172 as shown in FIG. 5, and the ROI 184 corresponds to the passenger-seat position 174 as shown in FIG. 5.

The radar device 10 locks the ROI where the human feature may exist in the interior space. In the following process, only the locked ROI(s) is (are) determined by the radar device 10 about whether any corresponding human feature exists. Therefore, the radar device 10 may confirm whether the indeterminate object corresponding to each locked ROI is a passenger.

In step S460, the microprocessor 140 determines whether the ROI in the distance-angle heatmap is associated with the human feature.

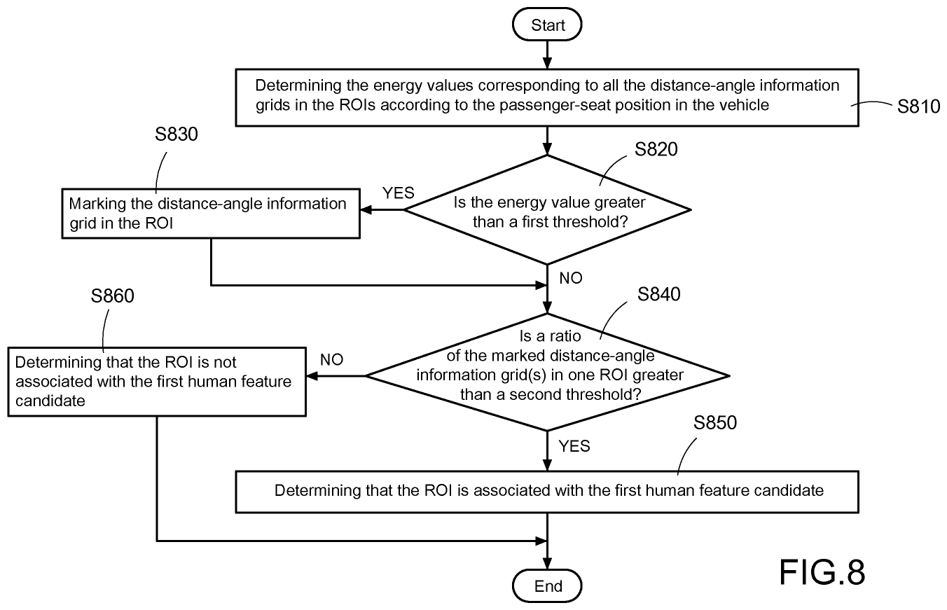

To further describe step S460, reference is made to FIG. 8. FIG. 8 is a flowchart of the in-vehicle-object detection method for performing a human feature detection process according to an embodiment of the present disclosure. The human feature detection process in FIG. 8 is performed by the radar device 10 in FIG. 3.

In step S810, the microprocessor 140 determines all the energy values corresponding to the distance-angle information grids in the ROIs according to the passenger-seat position in the vehicle 20.

In an embodiment, one ROI includes the plurality of distance-angle information grids.

In an embodiment, the microprocessor 140 computes the energy value of the distance-angle information grid by using the distance and the angle of the distance-angle information grid for each passenger-seat position. For example, the microprocessor 140 computes a sum of squares of the real part and the imaginary part of the receiving signals (frequency signals) corresponding to the passenger-seat position and then computes the positive square root of the sum of squares to be the energy value of the distance-angle information grid.

In an embodiment, the microprocessor 140 computes all the energy values of the distance-angle information grids for all the ROIs by the computing process above.

In step S820, the microprocessor 140 determines whether the energy value is greater than a first threshold. If the energy value is greater than the first threshold, the microprocessor 140 proceeds to step S830. If the energy value is not greater than the first threshold, the microprocessor 140 proceeds to step S840.

In step S830, the microprocessor 140 marks the distance-angle information grid in the ROI.

In an embodiment, the microprocessor 140 repeatedly performs steps S820 and S830 to determine the energy values of all the distance-angle information grids in the ROIs and mark the distance-angle information grid having the energy value greater than the first threshold.

It should be noted that the value of the first threshold is not limited and the person skilled in the art may set the suitable value for respective circumstances.

In step S840, the microprocessor 140 determines whether a ratio of the marked distance-angle information grid(s) in one ROI is greater than a second threshold. If the determination is yes, the microprocessor 140 proceeds to step S850. If the determination is no, the microprocessor 140 proceeds to step S860.

In an embodiment, the second threshold is associated with a quantity of the marked distance-angle information grids and the ratio of the marked distance-angle information grids to the total quantity of the distance-angle information grids in one ROI (such as 70%).

In step S850, the microprocessor 140 determines that the ROI is associated with the first human feature candidate.

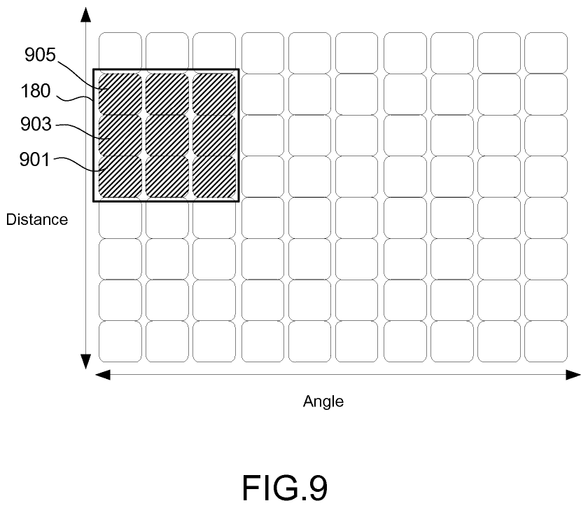

For further information on marking the distance-angle information grid in the ROI, reference is made to FIG. 9. FIG. 9 is a schematic diagram of marking the distance-angle-information grids in the ROIs according to an embodiment of the present disclosure.

As shown in FIG. 9, the ROI 180 includes the plurality of distance-angle information grids (such as 9), and each distance-angle information grid corresponds to one distance (such as the second distance) and one angle. As described above, the microprocessor 140 computes the energy values of all the distance-angle information grids of the ROI 180 and marks one or more of the distance-angle information grids whose energy value is greater than the first threshold, where the mark sign is shown as the slash in FIG. 9.

In FIG. 9, the quantity of the marked distance-angle information grids is 9, and the total quantity of the distance-angle information grids in the ROI 180 is 9. In the embodiment, the ratio of the marked distance-angle information grids in the ROI 180 is 100% which is greater than the second threshold such as 70%. Therefore, the microprocessor 140 determines that the ROI 180 is associated with the first human feature candidate.

In step S860, the microprocessor 140 determines that the ROI is not associated with the first human feature candidate.

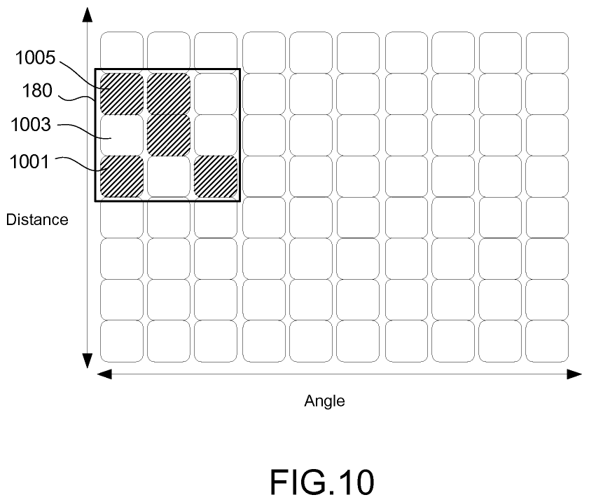

Reference is made to FIG. 10. FIG. 10 is a schematic diagram of marking the distance-angle-information grids in the ROIs according to another embodiment of the present disclosure.

In FIG. 10, the quantity of the marked distance-angle information grids in the ROI 180 is 5, and the total quantity of the distance-angle information grids in the ROI 180 is 9. In other words, the ratio of the marked distance-angle information grids in the ROI 180 is about 56% which is less than the second threshold such as 70%. In the embodiment, the microprocessor 140 determines that the ROI 180 is not associated with the first human feature candidate.

In an embodiment, the first human feature candidate is one factor to determine whether the indeterminate object corresponding to the ROI 180 is the passenger.

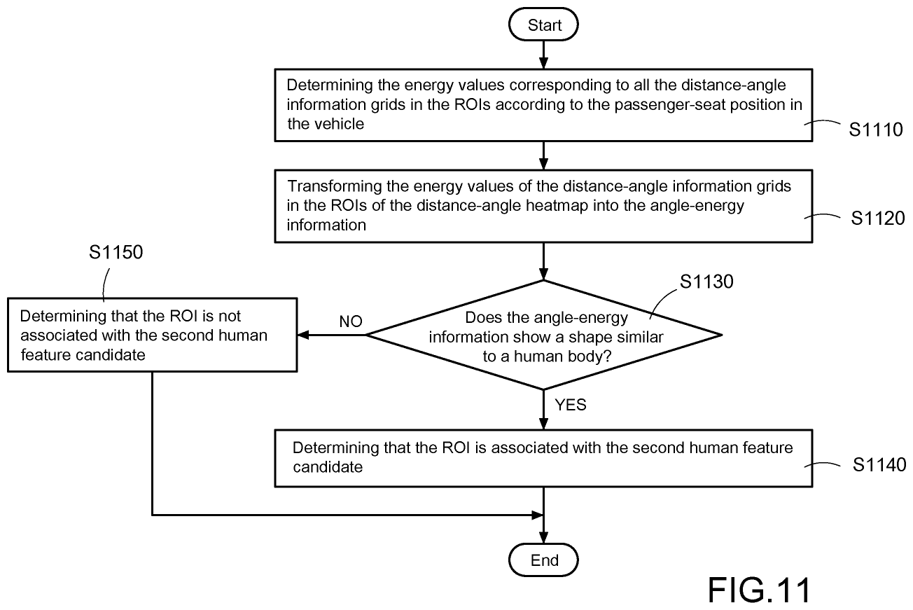

To further describe another process of step S460, reference is made to FIG. 11. FIG. 11 is a flowchart of the in-vehicle-object detection method for performing the human feature detection process according to another embodiment of the present disclosure. The human feature detection process in FIG. 11 is performed by the radar device 10 in FIG. 3.

In step S1110, the microprocessor 140 determines the energy values of all the distance-angle information grids corresponding to the ROIs according to the passenger-seat position in the vehicle 20. The description of step S1110 is similar to step S810 and not repeated.

In step S1120, the microprocessor 140 transforms the energy values of the distance-angle information grids in the ROIs of the distance-angle heatmap into the angle-energy information.

In step S1130, the microprocessor 140 determines whether the angle-energy information shows a shape similar to a human body. If the determination is yes, the microprocessor 140 proceeds to step S1140. If the determination is no, the microprocessor 140 proceeds to step S1150.

In step S1140, the microprocessor 140 determines that the ROI is associated with the second human feature candidate.

In step S1150, the microprocessor 140 determines that the ROI is not associated with the second human feature candidate.

For further information on transformation, reference is made to FIG. 9. In FIG. 9, the first column of the ROI 180 (corresponding to the first angle) includes the distance-angle information grids 901, 903, and 905. As described above, each distance-angle information grid has one corresponding energy value. In the embodiment, the microprocessor 140 computes the sum of the energy values corresponding to a first angle of the ROI 180, that is, computes the sum of the energy values of the distance-angle information grids 901, 903, and 905 to obtain a first energy sum. Similarly, the microprocessor 140 computes the sum of the energy values corresponding to a second angle (i.e., the second column) of the ROI 180 to obtain a second energy sum; the microprocessor 140 computes the sum of the energy values corresponding to a third angle (i.e., the third column) of the ROI 180 to obtain a third energy sum. For the sake of understanding, the energy sum corresponding to each angle is called “angle-energy information”.

The microprocessor 140 transforms the ROI 180 into the angle-energy information. In an embodiment, the microprocessor 140 draws an angle-energy information graph in accordance with the first angle, the first energy sum corresponding to the first angle, the second angle, the second energy sum corresponding to the second angle, the third angle, and the third energy sum corresponding to the third angle.

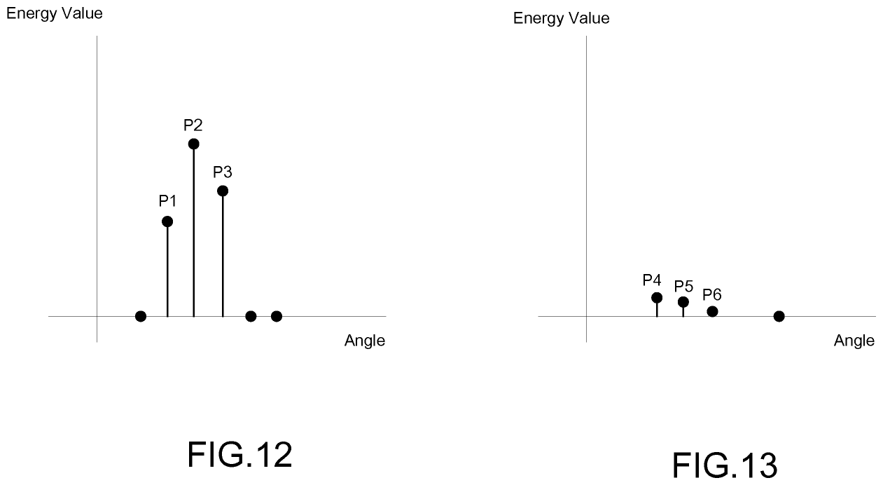

Reference is made to FIG. 12. FIG. 12 is a schematic diagram illustrating the angle-energy information according to an embodiment of the present disclosure.

As shown in FIG. 12, the X-axis indicates the angle and the Y-axis indicates the energy value. In the angle-energy information graph drew by the microprocessor 140, an energy value P1 (i.e., the first energy sum) corresponding to the first angle, an energy value P2 (i.e., the second energy sum) corresponding to the second angle, and an energy value P3 (i.e., the third energy sum) corresponding to the third angle are included.

In an embodiment, the microprocessor 140 determines whether the angle distribution of the energy values P1, P2, and P3 shows the shape similar to the human body. For example, the microprocessor 140 computes a median of the angles and determines whether the energy value corresponding to the median is the largest value and the energy values corresponding to the rest of two angles near the median angle are the smaller values. If the determination is yes, the microprocessor 140 determines that the ROI is associated with the second human feature candidate. In the embodiment, the shape similar to the human body indicates that the curve drawn by the microprocessor 140 with the angles and the energy values has a largest value in the middle (such as the head) and two lower values on the left and the right sides (such as the shoulder) of the largest value.

Reference is made to FIG. 10 and FIG. 13. FIG. 13 is a schematic diagram illustrating the angle-energy information according to another embodiment of the present disclosure. In FIG. 10, the first column (corresponding to a fourth angle) of the ROI 180 includes the distance-angle information grids 1001, 1003, and 1005. In the embodiment, the microprocessor 140 computes the sum of the energy values corresponding to the fourth angle of the ROI 180, that is, computes the sum of the energy values of the distance-angle information grids 1001, 1003, and 1005 to obtain a fourth energy sum. Similarly, the microprocessor 140 computes the sum of the energy values corresponding to a fifth angle (i.e., the second column) of the ROI 180 to obtain a fifth energy sum; the microprocessor 140 computes the sum of the energy values corresponding to a sixth angle (i.e., the third column) of the ROI 180 to obtain a sixth energy sum.

The microprocessor 140 transforms the ROI 180 into the angle-energy information. In an embodiment, the microprocessor 140 draws the angle-energy information graph of the ROI 180 in accordance with the fourth angle, the fourth energy sum corresponding to the fourth angle, the fifth angle, the fifth energy sum corresponding to the fifth angle, the sixth angle, and the sixth energy sum corresponding to the sixth angle.

As shown in FIG. 13, the X-axis indicates the angle, and the Y-axis indicates the energy value. The angle-energy information graph drew by the microprocessor 140 includes an energy value P4 (i.e., the fourth energy sum) corresponding to the fourth angle, an energy value P5 (i.e., the fifth energy sum) corresponding to the fifth angle, and an energy value P6 (i.e., the sixth energy sum) corresponding to the sixth angle.

In the embodiment, the microprocessor 140 determines whether the angle distribution of the energy values P4, P5, and P6 shows the shape similar to the human body. In the embodiment, the energy values P4, P5, and P6 are in the pattern of a decreasing trend which is unsimilar to the human body. Therefore, the microprocessor 140 determines that the ROI 180 is not associated with the second human feature candidate.

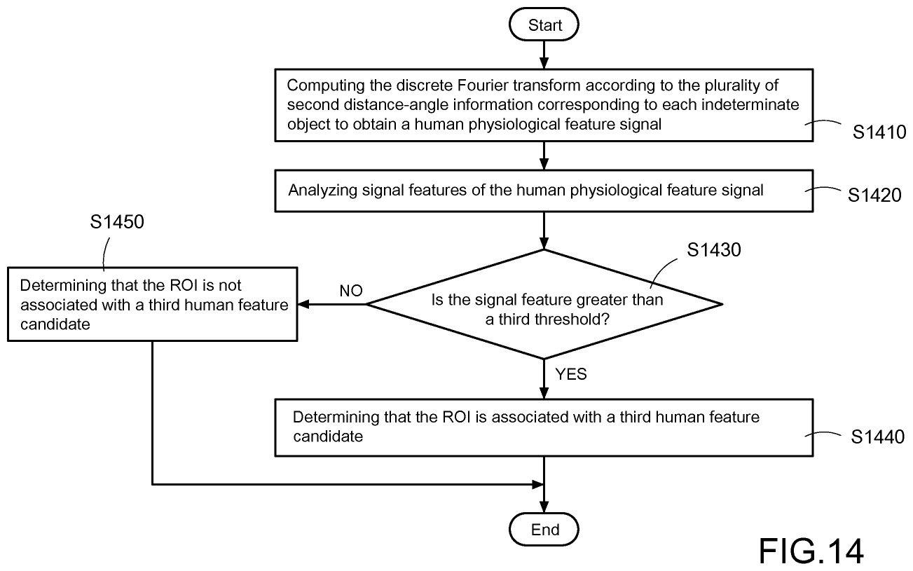

To further describe another process of step S460, reference is made to FIG. 14. FIG. 14 is a flowchart of the in-vehicle-object detection method for performing the human feature detection process according to another embodiment of the present disclosure. The human feature detection process in FIG. 14 is performed by the radar device 10 in FIG. 3.

In step S1410, the microprocessor 140 computes the discrete Fourier transform according to the plurality of second distance-angle information corresponding to each indeterminate object to obtain a human physiological feature signal.

In step S1420, the microprocessor 140 analyzes signal features of the human physiological feature signal.

In step S1430, the microprocessor 140 determines whether the signal feature is greater than a third threshold. If the determination is yes, the microprocessor 140 proceeds to step S1440. If the determination is no, the microprocessor 140 proceeds to step S1450.

In step S1440, the microprocessor 140 determines that the ROI is associated with a third human feature candidate.

In step S1450, the microprocessor 140 determines that the ROI is not associated with the third human feature candidate.

In an embodiment, the radar device 10 computes the discrete Fourier transform to the reflected radar-wave signals to obtain the frequency signals. If the indeterminate object is the passenger, the frequency signal will show the frequency period based on the passenger's breath and heartbeats. The microprocessor 140 utilizes the frequency signals to determine the human physiological feature signals and obtains multiple intervals by peak values of the physiological features that are greater than a preset value.

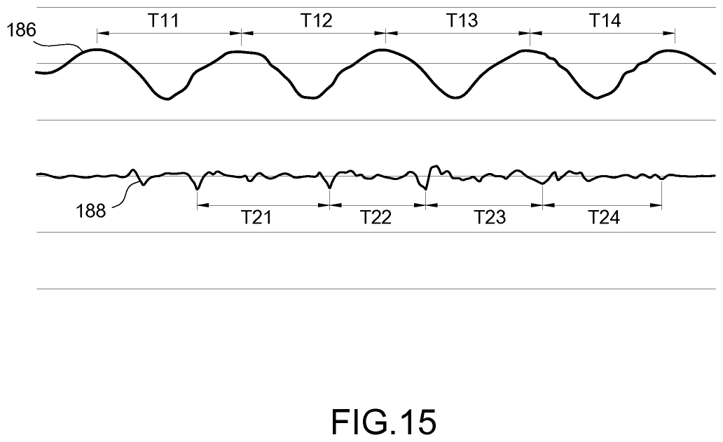

Reference is made to FIG. 15. FIG. 15 is a schematic diagram of analyzing human physiological feature signals according to an embodiment of the present disclosure.

As shown in FIG. 15, the microprocessor 140 obtains two human physiological feature signals 186 and 188 from the second distance-angle information of each indeterminate object. The microprocessor 140 analyzes the value of the human physiological feature signals 186 to obtain multiple intervals T11, T12, T13, and T14. Because the intervals T11, T12, T13, and T14 satisfy a fixed period, the microprocessor 140 regards the human physiological feature signal 186 as the human feature candidate.

Similarly, the microprocessor 140 analyzes the value of the human physiological feature signal 188 to obtain multiple intervals T21, T22, T23, and T24. Because the intervals T21, T22, T23, and T24 satisfy another fixed period, the microprocessor 140 regards the human physiological feature signal 188 as the human feature candidate.

In an embodiment, the human physiological feature signal 186 is the breath feature signal and the human physiological feature signal 188 is the heartbeats feature signal.

In an embodiment, the microprocessor 140 determines that the human physiological feature signals 186 and 188 are the human feature candidates only when both the human physiological feature signals 186 and 188 satisfy their fixed periods.

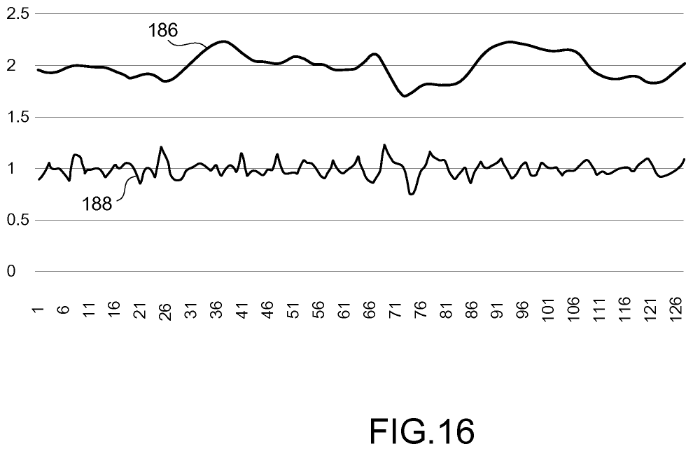

Reference is made to FIG. 16. FIG. 16 is a schematic diagram of analyzing the human physiological feature signals according to another embodiment of the present disclosure. The microprocessor 140 obtains two human physiological feature signals 186 and 188 from the second distance-angle information. The microprocessor 140 analyzes the values of the human physiological feature signals 186 and 188. The multiple intervals (i.e., the intervals greater than the third threshold) of the human physiological feature signals 186 and 188 shown in FIG. 16 do not satisfy the fixed periods though, the microprocessor 140 regards that the human physiological feature signals 186 and 188 are not associated with the human feature candidate.

It should be noted that obtaining the multiple intervals in step S1420 is not limited to determining whether the human physiological feature signal is greater than the third threshold, in particularly, other types of physiological feature signals may be applied in the present disclosure for analyzing the intervals. For example, the multiple intervals may also be obtained based on the value of the human physiological feature signal that is smaller than the threshold or the value that is falling within a predetermined range.

In an embodiment, the third human feature candidate is one of the factors of determining whether the indeterminate object corresponding to the ROI 180 is the passenger.

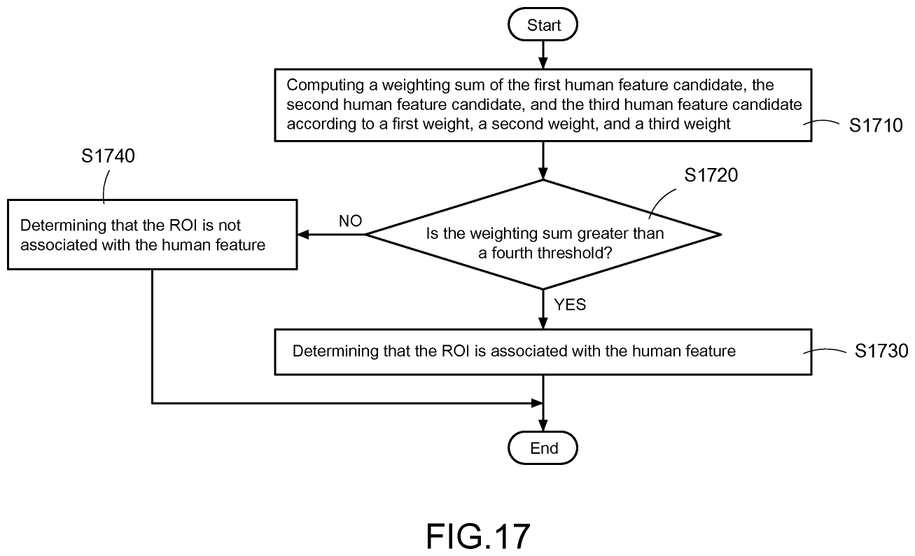

To further describe step S460 of determining whether the ROI is associated with the human feature, reference is made to FIG. 17. FIG. 17 is a flowchart of determining whether the ROI of the distance-angle heatmap is associated with the human features according to an embodiment of the present disclosure. The determination process in FIG. 17 is performed by the radar device 10 in FIG. 3.

In FIG. 17, the microprocessor 140 refers to the determination result (i.e., the first human feature candidate) of step S840 in FIG. 8, the determination result (i.e., the second human feature candidate) of step S1130 in FIG. 11, and the determination result (i.e., the third human feature candidate) of step S1430 of FIG. 14 at the same time for a further weight computation.

In step S1710, the microprocessor 140 computes a weighting sum of the determination result of the first human feature candidate, the determination result of the second human feature candidate, and the determination result of the third human feature candidate according to a first weight, a second weight, and a third weight.

The computation of the weighting sum may be performed based on the formula: Decision_{Final}=w₁×Decision₁+w₂×Decision₂+w₃×Decision₃, where w₁ is the first weight, w₂ is the second weight, w₃ is the third weight; Decision₁ is the determination result of the first human feature candidate, Decision₂ is the determination result of the second human feature candidate, and Decision₃ is the determination result of the third human feature candidate.

In an embodiment, if the determination result of step S840 in FIG. 8 is yes (i.e., the next step is step S850), Decision₁ is indicated by 1; if the determination result of step S840 is no (i.e., the next step is step S860), Decision₁ is indicated by 0. Decision₂ and Decision₃ are obtained by the similar way based on the determination results of step S1130 in FIG. 11 and step S1430 in FIG. 14.

In an embodiment, the first weight, the second weight, and the third weight are decimal numbers that are greater than 0 but less than 1, and the sum of the first weight, the second weight, and the third weight is 1.

In step S1720, the microprocessor 140 determines whether the weighting sum is greater than a fourth threshold. If the determination is yes, the microprocessor 140 proceeds to step S1730. If the determination is no, the microprocessor 140 proceeds to step S1740.

In step S1730, the microprocessor 140 determines that the ROI is associated with the human feature. In other words, the radar device 10 determines that the indeterminate object corresponding to the ROI is related to the human body.

In step S1740, the microprocessor 140 determines that the ROI is not associated with the human feature.

In FIG. 17, the microprocessor 140 comprehensively estimates whether the ROI is associated with the human feature based on the multiple determination results to improve the accuracy of detecting the object in the vehicle.

It should be noted that, in addition to the ROI 180 as shown in FIG. 7, the microprocessor 140 also performs the human feature detection processes as shown in FIG. 8, FIG. 11, FIG. 14, and FIG. 17 to the ROIs 176, 178, 182, and 184 in FIG. 7 respectively, but the descriptions are not repeated for the sake of the concise.

Accordingly, the radar device 10 and the in-vehicle-object detection method for the radar device 10 create the distance-angle heatmap, detect the angles and the distances of the space objects with respect to the radar device 10, select the ROIs with the space object in the distance-angle heatmap, and estimate whether the ROIs are associated with the human feature one by one to obtain the correct detection result. Compared with the related art that needs to compute the coordinates while the signals are received to obtain the coordinates of the objects, the disclosure eliminates the coordinate computation process of the objects. While the disclosure eliminates the coordinate computation process of the objects, finding the ROIs in the distance-angle heatmap to scale down the area to search the indeterminate object not only decreases the computation of the microprocessor but also increases the accuracy of detecting whether the object in the vehicle is related to the passenger.

It will be apparent to those skilled in the art that various modifications and variations can be made to the structure of the present disclosure without departing from the scope or spirit of the disclosure. In view of the foregoing, it is intended that the present disclosure cover modifications and variations of this disclosure provided they fall within the scope of the following claims.

What is claimed is:

1. An in-vehicle-object detection method for a radar device, comprising:
a) obtaining a plurality of receiving signals corresponding to a plurality of space objects by an antenna array of the radar device;
b) computing a plurality of first distances between the antenna array and the plurality of space objects based on the plurality of receiving signals;
c) filtering a background noise of the plurality of first distances to obtain a plurality of second distances between a plurality of indeterminate objects of the plurality of space objects and the antenna array;
d) performing a beamforming based on the plurality of second distances to compute a plurality of angle information each corresponding to each of the plurality of second distances;
e) generating a distance-angle heatmap comprising a plurality of regions of interest (ROIs), wherein each of the plurality of ROIs corresponds to a passenger-seat position in the vehicle; and
f) determining whether each of the plurality of ROIs in the distance-angle heatmap is associated with a human feature to decide whether each of the indeterminate objects is related to a human or an unhuman.

2. The in-vehicle-object detection method for a radar device of claim 1, wherein step b) further comprises:
computing a discrete Fourier transform to transform the plurality of receiving signals of the antenna array to be the plurality of first distances.

3. The in-vehicle-object detection method for a radar device of claim 1, wherein step c) further comprises:
removing distances corresponding to a speed being close to zero from the plurality of first distances to obtain the plurality of second distances.

4. The in-vehicle-object detection method for a radar device of claim 1, wherein step d) further comprises:
computing a discrete Fourier transform to the plurality of second distances whose background noises are filtered to obtain the plurality of angle information from the plurality of second distances whose background noises are filtered and obtaining a plurality of second distance-angle information each comprising the plurality of second distances and the plurality of angle information.

5. The in-vehicle-object detection method for a radar device of claim 1, wherein each of the plurality of ROIs comprises a plurality of distance-angle information grids, and step f) comprises:
determining an energy value of each of the distance-angle information grids corresponding to each of the plurality of the ROIs according to the passenger-seat position in the vehicle;
marking one of the distance-angle information grids in one of the ROIs when the energy value of the distance-angle information grid is determined to be greater than a first threshold; and
determining that one of the ROIs is associated with a first human feature candidate when a ratio of the distance-angle information grids being marked in the ROI is greater than a second threshold.

6. The in-vehicle-object detection method for a radar device of claim 5, wherein step f) further comprises:
transforming the energy values of the distance-angle information grids in each of the plurality of the ROIs of the distance-angle heatmap into a plurality of angle-energy information; and
determining that one of the ROIs is associated with a second human feature candidate when the angle-energy information of the ROI shows a shape similar to a human body.

7. The in-vehicle-object detection method for a radar device of claim 6, wherein step f) further comprises:
computing a discrete Fourier transform according to the plurality of the second distance-angle information of each of the plurality of the ROIs to obtain a human physiological feature signal; and
determining that one of the pluralities of the ROIs is a third human feature candidate when the human physiological feature signal of the ROI is greater than a third threshold.

8. The in-vehicle-object detection method for a radar device of claim 7, wherein step f) further comprises:
computing a weighting sum of a first determination result of the first human feature candidate, a second determination result of the second human feature candidate, and a third determination result of the third human feature candidate according to a first weight, a second weight, and a third weight for each of the plurality of ROIs; and
determining that one of the ROIs is associated with the human feature when the weighting sum of the ROI is greater than a fourth threshold.

9. A radar device for detecting an object in a vehicle, comprising:
an antenna array, configured to receive a plurality of receiving signals; and
a microprocessor, connected to the antenna array and configured to perform operations comprising:
a) obtaining the plurality of receiving signals corresponding to a plurality of space objects;
b) computing a plurality of first distances between the antenna array and the plurality of space objects based on the plurality of receiving signals;
c) filtering a background noise of the plurality of first distances to obtain a plurality of second distances between a plurality of indeterminate objects of the plurality of space objects and the antenna array;
d) performing a beamforming based on the plurality of second distances to compute a plurality of angle information each corresponding to each of the plurality of second distances;
e) generating a distance-angle heatmap comprising a plurality of regions of interest (ROIs), wherein each of the plurality of ROIs corresponds to a passenger-seat position in the vehicle; and
f) determining whether each of the plurality of ROIs in the distance-angle heatmap is associated with a human feature to decide whether each of the indeterminate objects is related to a human or an unhuman.

10. The radar device of claim 9, wherein the operation b) performed by the microprocessor comprises:
computing a discrete Fourier transform to transform the plurality of receiving signals of the antenna array to be the plurality of first distances.

11. The radar device of claim 9, wherein the operation c) performed by the microprocessor comprises:
removing distances corresponding to a speed being close to zero from the plurality of first distances to obtain the plurality of second distances.

12. The radar device of claim 9, wherein the operation d) performed by the microprocessor comprises:
computing a discrete Fourier transform to the plurality of second distances whose background noises are filtered to obtain the plurality of angle information from the plurality of second distances whose background noises are filtered and obtaining a plurality of second distance-angle information each comprising the plurality of second distances and the plurality of angle information.

13. The radar device of claim 9, wherein each of the plurality of ROIs comprises a plurality of distance-angle information grids, and the operation f) performed by the microprocessor comprises:
determining an energy value of each of the distance-angle information grids corresponding to each of the plurality of the ROIs according to the passenger-seat position in the vehicle;
marking one of the distance-angle information grids in one of the ROIs when the energy value of the distance-angle information grid is determined to be greater than a first threshold; and
determining that one of the ROIs is associated with a first human feature candidate when a ratio of the distance-angle information grids being marked in the ROI is greater than a second threshold.

14. The radar device of claim 13, wherein the operation f) performed by the microprocessor further comprises:
transforming the energy values of the distance-angle information grids in each of the plurality of the ROIs of the distance-angle heatmap into a plurality of angle-energy information; and
determining that one of the ROIs is associated with a second human feature candidate when the angle-energy information of the ROI shows a shape similar to a human body.

15. The radar device of claim 14, wherein the operation f) performed by the microprocessor further comprises:
computing a discrete Fourier transform according to the plurality of the second distance-angle information of each of the plurality of the ROIs to obtain a human physiological feature signal; and
determining that one of the pluralities of the ROIs is a third human feature candidate when the human physiological feature signal of the ROI is greater than a third threshold.

16. The radar device of claim 15, wherein the operation f) performed by the microprocessor further comprises:
computing a weighting sum of a first determination result of the first human feature candidate, a second determination result of the second human feature candidate, and a third determination result of the third human feature candidate according to a first weight, a second weight, and a third weight for each of the plurality of ROIs; and
determining that one of the ROIs is associated with the human feature when the weighting sum of the ROI is greater than a fourth threshold.
